(19) United States
(12) Patent Application Publication
(10) Pub. No.: US 2012/0115389 A1
(43) Pub. Date: May 10, 2012

(54) METHOD FOR MANUFACTURING ELECTRONIC PAPER DISPLAY DEVICE

(75) Inventors: Sang Jin KIM, Gyeonggi-do (KR); Jeong Bok Kwak, Gyeonggi-do (KR); Jung Min Park, Gyeonggi-do (KR); Sang Moon Lee, Seoul (KR)

(73) Assignee: SAMSUNG ELECTRO-MECHANICS CO., LTD.

(21) Appl. No.: 13/281,960

(22) Filed: Oct. 26, 2011

(30) Foreign Application Priority Data
Nov. 4, 2010 (KR) 10-2010-0109214

(51) Int. Cl. H01J 9/00

(52) U.S. Cl. 445/24

(57) ABSTRACT

Disclosed herein is a method for manufacturing an electronic paper display device, including: laminating a dry film on a first electrode; performing exposing and developing processes on the dry film to form barriers defining cells; injecting electronic balls into the cells; and binding a second electrode onto the first electrode including the electronic balls.

### CROSS REFERENCE(S) TO RELATED APPLICATIONS

This application claims the benefit under 35 U.S.C. Section 119 of Korean Patent Application Serial No. 10-2010-0109214, entitled “Method for Manufacturing Electronic Paper Display Device” filed on Nov. 4, 2010, which is hereby incorporated by reference in its entirety into this application.

### BACKGROUND OF THE INVENTION

1. Technical Field

The present invention relates to a method for manufacturing an electronic paper display device, and more particularly, to a method for manufacturing an electronic paper display device capable of forming barriers defining cells for injecting electronic balls thereinto by using a dry film.

2. Description of the Related Art

As the next generation display devices, a liquid crystal display (LCD), a plasma display panel (PDP), an organic electroluminescent device, an electronic paper display device, and the like are widely distributed.

Among them, the electronic paper display device is flexiblybendable, and has much low production cost as compared with other display devices.

In addition, since the electronic paper display device does not require background lighting or continuous recharging, it can be driven even with low energy, and thereby have superior excellent energy efficiency. In addition, the electronic paper display device has a clear screen and a wide viewing angle, and can have a memory function in which displayed letters or images does not completely disappear even when power supply is promptly cut, and thus, bendable screens including printed media, such as a book, a paper, a magazine, or the like, and an electronic wallpaper can be anticipated to be extensively used in a wide range of fields.

Meanwhile, the electronic paper display device may include twist balls, which are interposed between two electrodes and driven by a voltage applied between the two electrodes, to display an image. Here, the twist balls are interposed between the two electrodes and can be driven within cells defined by barriers.

Here, the barriers may be formed by preparing a film layer and the performing exposing and developing processes on the film layer. Here, due to heat applied during formation of the film layer, the color of the film layer is changed from transparent to opaque, that is, a pale orange color, and thus, the barriers may be opaque.

As such, the opaque color of the barriers may have an effect on the colors generated by mixing red, blue and green colors, and thus, brightness and chroma of the electronic paper display device are deteriorated.

Also, when the electronic paper display device exhibits black and white, the color of the barriers may be recognized by a user, which makes the user uncomfortable when watching images.

### SUMMARY OF THE INVENTION

An object of the invention is to provide a method for manufacturing an electronic paper display device capable of maintaining transparency of barriers, which define cells for injecting electronic balls thereinto, by using a dry film to form the barriers.

According to the exemplary embodiment of the present invention, there is provided a method for manufacturing an electronic paper display device, including: laminating a dry film on a first electrode; performing exposing and developing processes on the dry film to form barriers defining cells; injecting electronic balls into the cells; and binding a second electrode onto the first electrode including the electronic balls.

The dry film may be formed of a material of a photopolymerizable compound (polyester-based urethane acrylate, 2,2-bis[4-(methacryloxypolyethoxy) phenyl]propane), a polymerization inhibitor (monomethyleter hyroquinone, benzophenone as a photopolymerization initiator, 4,4′bisdiethylamino benzophenone), a colorant (leuco crystal violet, toluenesulfonic acid monohydrate), and a binder polymer (acylic acid, methacylic acid, and methacrylate), to have a transparent property.

In the performing of the exposing and developing processes on the dry film to form barriers defining cells, the exposing process may be performed at an energy density of 80 mJ to 150 mJ.

In the performing of the exposing and developing processes on the dry film to form barriers defining cells, the number of developing processes may be 15 to 22.

The electronic ball may be a twist ball or a microcapsule.

### BRIEF DESCRIPTION OF THE DRAWINGS

FIGS. 1 to 4 are cross-sectional views for explaining a method of manufacturing an electronic paper display device according to an exemplary embodiment of the present invention.

### DESCRIPTION OF THE PREFERRED EMBODIMENTS

Hereinafter, the exemplary embodiments of the present invention will be described in detail with reference to the drawings of an electronic paper display device. The exemplary embodiments to be described below are provided by way of example so that the idea of the present invention can be sufficiently transferred to those skilled in the art.

Therefore, the present invention may be modified in many different forms and it should not be limited to the embodiments set forth herein. In the drawings, the size and the thickness of the apparatus may be exaggerated for convenience. Like reference numerals denote like elements throughout the specification.

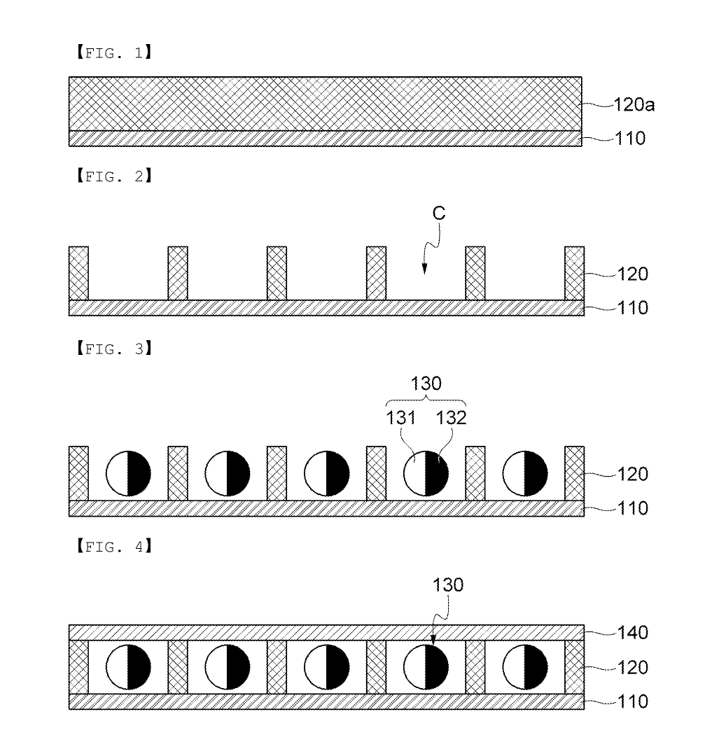

FIGS. 1 to 4 are cross-sectional views for explaining a method of manufacturing an electronic paper display device according to an exemplary embodiment of the present invention.

Referring to FIG. 1, a first electrode 110 is first provided, in order to manufacture the electronic paper display device. Here, the first electrode 110 may include a conductive substrate functioning to support the electronic paper display device. However, the exemplary embodiment of the present invention does not limit a shape of the first electrode 110. The first electrode 110 may be provided on the substrate by using a conductive film.

Here, the first electrode 110 may be a reflective electrode or a transparent electrode. The first electrode 110 may be made of a light reflective type conductive material or a light transmissive type conductive material. For example, the light reflective type conductive material may be a metal, such as Cu and Ag. In addition, examples of the light transmissive type conductive material may be ITO, IZO, ITZO, and the like.

Then, a transparent dry film is laminated on the first electrode 110 to form a transparent film layer 120a on the first electrode 110. Here, the transparent dry film may be made of a material unchangeable by applied heat during a laminating procedure. Here, examples of the material for forming the transparent dry film may include a photopolymerizable compound (polyester-based urethane acrylate, 2,2-bis[4-(methacryloxypolyethoxy) phenyl]propane), a polymerization inhibitor (monomethyleter hyroquinone, benzophenone as a photopolymerization initiator, 4,4′bisdiethylamino benzophenone), a colorant (leuco crystal violet, toluenesulfonic acid monohydrate), and a binder polymer (acylic acid, methacylic acid, and methlymeacrylate).

Here, the transparent film layer 120a is described to be formed through one laminating procedure of the dry film, but the formation of the transparent film. layer 120a is not limited thereto. In other words, the dry film may be laminated several times until the transparent film layer 120a has a predetermined thickness. Therefore, the thickness of the transparent film layer 120a can be more easily controlled according to the predetermined laminating number of dry films than a case where the transparent film layer 120a is formed through a coating process of resin.

Referring to FIG. 2, exposing and developing processes are performed on the transparent film layer 120a to form barriers 120 defining cells C.

Here, the barriers 120 maybe formed to have a lateral surface vertical to the first electrode 110 by controlling the conditions of exposing and developing processes.

The exposing process may be performed at an energy density of 80 mJ to 150 mJ. If the exposure intensity is below 80 mJ, the barriers may be difficult to form. If the exposure intensity is above 150 mJ, the barriers may be formed to have a lateral surface having a predetermined slope with respect to the first electrode 110 due to scattering of light.

In addition, an alkaline solution, that is, a solution obtained by diluting sodium carbonate (Na₂CO₃) with water may be used during the developing process. Here, the shape of the lateral surface of the barrier may be influenced by the number of developing processes. In other words, when the dry film resist is laminated several times, it may have a thickness of 50 to 120 μm and the number of developing processes may be 15 to 22. Here, if the number of developing processes is below 15, under-developing may occur, resulting in less etching. If the number of developing processes is above 22, overdeveloping may occur, resulting in destroying the barriers.

The electronic balls 130 can be driven or rotate more smoothly when the barrier 120 has a lateral surface vertical to the first electrode 110 than when the barrier 120 has a predetermined slope with respect to the first electrode 110. In addition, since the barrier 120 has a lateral surface vertical to the first electrode 110, an electric field for driving the electronic balls 130 can be prevented from being distorted.

Referring to FIG. 3, the electronic balls 130 were injected into the cells C defined by the barriers 120.

Here, the electronic ball 130 may be a twist ball configured to include a first hemisphere 131 and a second hemisphere 132 exhibiting different colors. The first hemisphere 131 may be made of a light reflecting material, and the second hemisphere 132 may be made of a light absorbing material. Meanwhile, the first hemisphere 131 may exhibit white color, and the second hemisphere 132 may exhibit a predetermined color, for example, anyone of red, blue, and green. Here, the electronic balls 130 according to the colors are injected into respective plurality of cells C in order to realize various colors. Here, an electronic paper display device can exhibit various colors by mixing colors through the driving of the electronic balls 130 according to the colors.

Here, the first hemisphere 131 and the second hemisphere 132 are charged with different types of charges, and thus they are rotated by an electric field applied to each of the cells C. Therefore, the first hemisphere 131 or the second hemisphere 132 can be selectively viewed to a user. Here, an image can be displayed according to the first hemisphere 131 and the second hemisphere 132 viewed on a surface of the electronic paper display device.

In order to inject the electronic balls 130, a mask having openings corresponding to the cells C is disposed over the cells C, and then the electronic balls 130 are dropped on the mask. Then, a squeeze is moved on the mask, thereby injecting the electronic balls 130 in respective cells C through the mask.

Referring to FIG. 4, after the electronic balls 130 fill the cells C, the second electrode 140 is bonded to the first electrode 110 including the electronic balls 130.

Then, a dielectric liquid fills respective cells C including the electronic balls 130. The filling of the dielectric liquid may be performed by impregnating the bonded first electrode and second electrode 110 and 140 with the dielectric liquid. Here, the dielectric liquid may fill into the cells through the barriers 120 between the first electrode 110 and the second electrode 140.

In this case, a liquid-phase material performing liquid-phase photo conversion and having lubricant component, for example, Dow Corning 10, Centistoke 200, or the like, may be used as the dielectric liquid.

In the embodiment of the present invention, the electronic ball 130 is described to be as a twist ball, but it is not limited thereto. For example, the electronic ball 130 maybe a microcapsule. In this case, when the electronic ball 130 is a microcapsule, a process of filling the dielectric liquid may be omitted.

Therefore, like the present embodiment of the present invention, as the barrier is formed by the transparent dry film, the deterioration in chroma and brightness due to color change of the barrier can be prevented.

In addition, in the electronic paper display device according to the exemplary embodiment of the present invention, as the barrier is formed to have a lateral surface vertical with respect to a lower electrode by modification of exposing and developing processes, the electronic balls can be smoothly driven and an electric field can be prevented from being distorted.

As set forth above, the electronic paper display device according to the present invention can prevent the deterioration in chroma and brightness due to color change of the barrier by forming the barrier using the transparent dry film.

Furthermore, the electronic paper display device according to the exemplary embodiment of the present invention can allow the electronic balls to be smoothly driven, and can prevent the distortion of an electric field, by forming the barrier to have a lateral surface vertical with respect to a lower electrode through modification of exposing and developing processes for forming the barrier.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A method for manufacturing an electronic paper display device, comprising:
laminating a dry film on a first electrode;
performing exposing and developing processes on the dry film to form barriers defining cells;
injecting electronic balls into the cells; and
binding a second electrode onto the first electrode including the electronic balls.

2. The method according to claim 1, wherein the dry film is formed of a material of a photopolymerizable compound (polyester-based urethane acrylate, 2,2-bis[4-(methacryloxypolyethoxy) phenyl]propane), a polymerization inhibitor (monomethyleter hyroquinone, benzophenone as a photopolymerization initiator, 4,4′bisdiethylamino benzophenone), a colorant (leuco crystal violet, toluenesulfonic acid monohydrate), and a binder polymer (acylic acid, methacylic acid, and methacrylate), to have a transparent property.

3. The method according to claim 1, wherein in the performing of the exposing and developing processes on the dry film to form barriers defining cells, the exposing process is performed at an energy density of 80 mJ to 150 mJ.

4. The method according to claim 1, wherein in the performing of the exposing and developing processes on the dry film to form barriers defining cells, the number of developing processes is 15 to 22.

5. The method according to claim 1, wherein the electronic ball is a twist ball or a microcapsule.
